(19) United States
(12) Patent Application Publication
(10) Pub. No.: US 2025/0174877 A1
(43) Pub. Date: May 29, 2025

(54) COMMUNICATION DEVICE

(71) Applicant: Wistron NeWeb Corp., Hsinchu (TW)

(72) Inventors: Chih-Feng TAI, Hsinchu (TW); Kuan-Hsun LAI, Hsinchu (TW); Chia-Yao HSU, Hsinchu (TW)

(21) Appl. No.: 18/931,184

(22) Filed: Oct. 30, 2024

(30) Foreign Application Priority Data
Nov. 24, 2023 (TW) 112145565

(51) Int. Cl. H01Q 1/24; H01Q 1/48; H01Q 5/357

(52) U.S. Cl. CPC H01Q 1/243; H01Q 1/48; H01Q 5/357

(57) ABSTRACT

A communication device includes a metal frame element, a ground element, a feeding radiation element, a first radiation element, a second radiation element, a third radiation element, and a nonconductive support element. The ground element is coupled to a first connection point on the metal frame element. The first radiation element is coupled to the ground element. The first radiation element is adjacent to the feeding radiation element. The second radiation element is coupled to a second connection point on the metal frame element. The second radiation element is adjacent to the feeding radiation element. The third radiation element is coupled to the ground element. The third radiation element is adjacent to the feeding radiation element. The antenna structure is formed by the metal frame element, the ground element, the feeding radiation element, the first radiation element, the second radiation element, and the third radiation element.

### CROSS REFERENCE TO RELATED APPLICATIONS

This application claims priority of Taiwan Patent Application No. 112145565 filed on Nov. 24, 2023, the entirety of which is incorporated by reference herein.

### BACKGROUND OF THE DISCLOSURE

### Field of the Disclosure

The disclosure generally relates to a communication device, and more particularly, to a communication device and an antenna structure thereof.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Generally, current designers often add metal components into mobile devices. However, the added metal components may negatively affect the antennas' ability to support wireless communication in mobile devices, thereby degrading the overall communication quality of the mobile devices. Accordingly, there is a need to propose a novel solution for solving the problems of the prior art.

### BRIEF SUMMARY OF THE DISCLOSURE

In an exemplary embodiment, the disclosure is directed to a communication device that includes a metal frame element, a ground element, a feeding radiation element, a first radiation element, a second radiation element, a third radiation element, and a nonconductive support element. The ground element is coupled to a first connection point on the metal frame element. The feeding radiation element has a feeding point. The first radiation element is coupled to the ground element. The first radiation element is adjacent to the feeding radiation element. The second radiation element is coupled to a second connection point on the metal frame element. The second radiation element is adjacent to the feeding radiation element. The third radiation element is coupled to the ground element. The third radiation element is adjacent to the feeding radiation element. The nonconductive support element is disposed on the metal frame element. The ground element, the feeding radiation element, the first radiation element, the second radiation element, and the third radiation element are distributed over the nonconductive support element. The antenna structure is formed by the metal frame element, the ground element, the feeding radiation element, the first radiation element, the second radiation element, and the third radiation element.

### BRIEF DESCRIPTION OF DRAWINGS

The disclosure can be more fully understood by reading the subsequent detailed description and examples with references made to the accompanying drawings, wherein:

FIG. 1 is a perspective view of a communication device according to an embodiment of the disclosure;

FIG. 2 is a front view of a communication device according to an embodiment of the disclosure;

FIG. 3 is a top view of a communication device according to an embodiment of the disclosure; and

FIG. 4 is a back view of a communication device according to an embodiment of the disclosure.

### DETAILED DESCRIPTION OF THE DISCLOSURE

In order to illustrate the purposes, features and advantages of the disclosure, the embodiments and figures of the disclosure are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

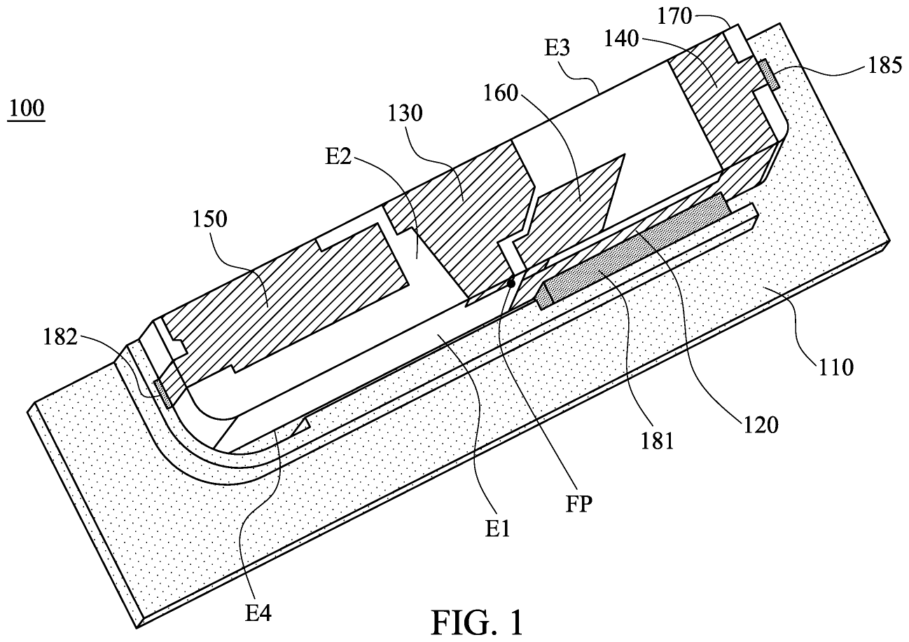

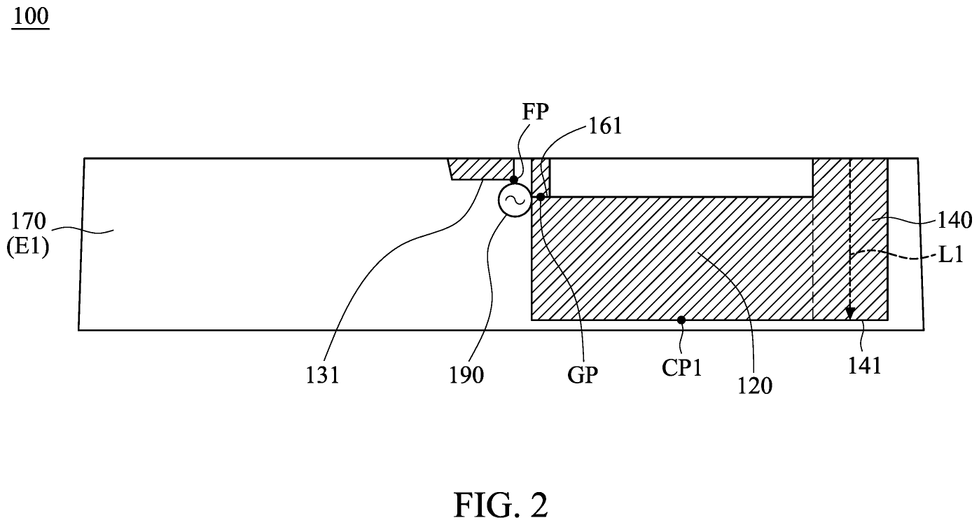

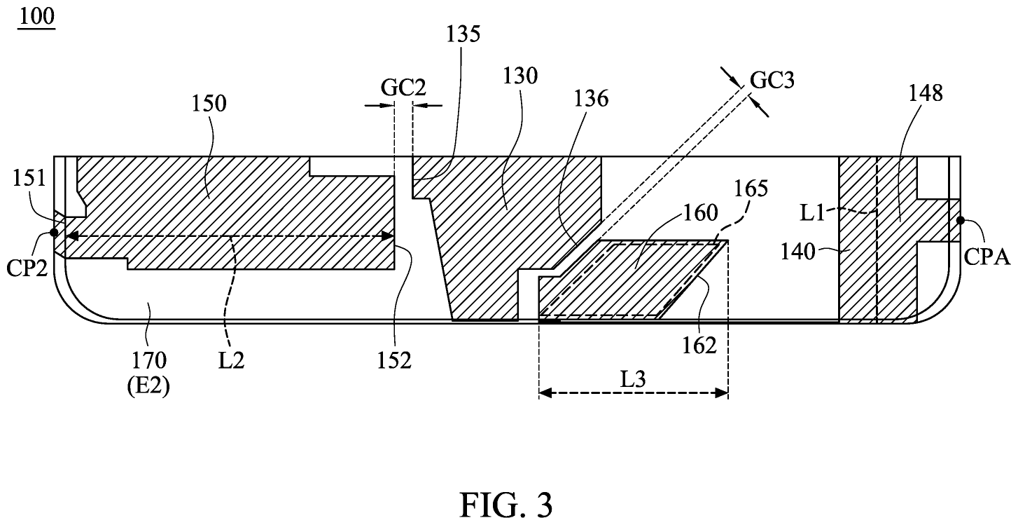

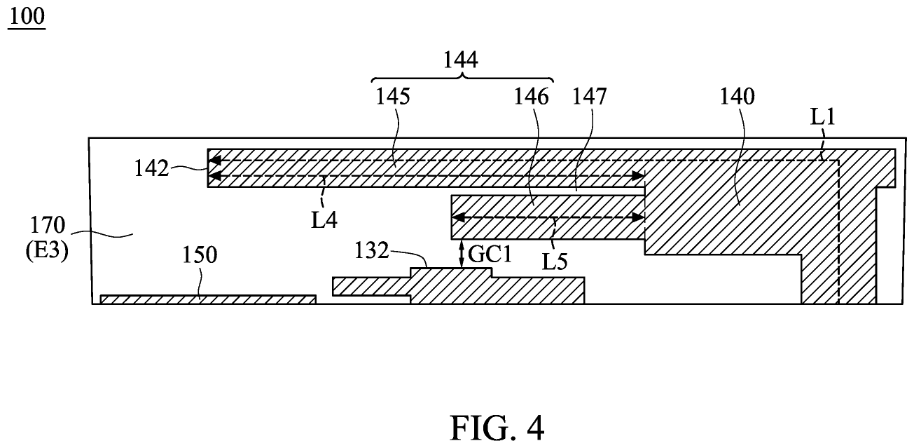

FIG. 1 is a perspective view of a communication device 100 according to an embodiment of the disclosure. FIG. 2 is a front view of the communication device 100 according to an embodiment of the disclosure. FIG. 3 is a top view of the communication device 100 according to an embodiment of the disclosure. FIG. 4 is a back view of the communication device 100 according to an embodiment of the disclosure. Please refer to FIGS. 1 to 4 together. For example, the communication device 100 may be a smart phone, a tablet computer, or a notebook computer, but it is not limited thereto.

In the embodiment of FIGS. 1 to 4, the communication device 100 includes a metal frame element 110, a ground element 120, a feeding radiation element 130, a first radiation element 140, a second radiation element 150, a third radiation element 160, and a nonconductive support element 170. The ground element 120, the feeding radiation element 130, the first radiation element 140, the second radiation element 150, and the third radiation element 160 may all be made of metal materials, such as copper, silver, aluminum, iron, or their alloys. It should be understood that the communication device 100 may further include other components, such as a processor, a touch-control module, a speaker, a power-supply module, and a housing, although they are not displayed in FIGS. 1 to 4.

The metal frame element 110 may be an internal component of the communication device 100, and it can enhance the structural rigidity of the communication device 100. For example, if the communication device 100 is a tablet computer, the metal frame element 110 may be an internal frame of the tablet computer, and it can be configured to carry a variety of electronic components (not shown). In other words, users cannot directly see the metal frame element 110 of the communication device 100. According to practical measurements, the incorporation of the metal frame element 110 helps the communication device 100 to easily pass the drop test. In some embodiments, the metal frame element 110 is also considered as a system ground element of the communication device 100.

The nonconductive support element 170 is disposed on the metal frame element 110. For example, the nonconductive support element 170 may substantially have a cuboid shape, but it is not limited thereto. It should be understood that the ground element 120, the feeding radiation element 130, the first radiation element 140, the second radiation element 150, and the third radiation element 160 are distributed over the nonconductive support element 170. Specifically, the nonconductive support element 170 has a first surface E1, a second surface E2, a third surface E3, and a fourth surface E4. The second surface E2 may be positioned between the first surface E1 and the third surface E3. The fourth surface E4, which is opposite to the second surface E2, may be attached to the metal frame element 110. In addition, the third surface E3 may be connected to the first surface E1 through the second surface E2. Both the first surface E1 and the third surface E3 may be substantially perpendicular to the second surface E2.

The ground element 120 may be disposed on the first surface E1 of the nonconductive support element 170. The ground element 120 is coupled to a first connection point CP1 on the metal frame element 110. For example, the ground element 120 may have a grounding point GP, which may be positioned at a corner of the ground element 120. In some embodiments, the ground element 120 substantially has a rectangular shape, but it is not limited thereto.

The feeding radiation element 130 is disposed between the second radiation element 150 and the third radiation element 160. The feeding radiation element 130 may extend from the first surface E1 through the second surface E2 onto the third surface E3 of the nonconductive support element 170. Specifically, the feeding radiation element 130 has a first end 131 and a second end 132. A feeding point FP is positioned at the first end 131 of the feeding radiation element 130. The second end 132 of the feeding radiation element 130 is an open end. For example, a positive electrode of a signal source 190 may be coupled to the feeding point FP of the feeding radiation element 130, and a negative electrode of the signal source 190 may be coupled to the grounding point GP of the ground element 120. Also, the feeding radiation element 130 has a first side 135 and a second side 136 which are opposite to each other. In some embodiments, the feeding radiation element 130 substantially has a variable-width polygonal shape, but it is not limited thereto.

The first radiation element 140 may also extend from the first surface E1 through the second surface E2 onto the third surface E3 of the nonconductive support element 170. Specifically, the first radiation element 140 has a first end 141 and a second end 142. The first end 141 of the first radiation element 140 is coupled to the ground element 120. The second end 142 of the first radiation element 140 is an open end. In some embodiments, the first radiation element 140 further includes a bifurcated portion 144 positioned at the second end 142. For example, the aforementioned bifurcated portion 144 may include a long branch 145 and a short branch 146, and a slot 147 may be formed between the long branch 145 and the short branch 146. However, the disclosure is not limited thereto. In alternative embodiments, the slot 147 is completely filled, such that the shape of the aforementioned bifurcated portion 144 can be modified correspondingly. In other words, the detailed structure of the first radiation element 140 is adjustable according to different requirements. In some embodiments, the first radiation element 140 is adjacent to the feeding radiation element 130. Thus, a first coupling gap GC1 may be formed between the second end 132 of the feeding radiation element 130 and the bifurcated portion 144 (or the short branch 146) of the first radiation element 140. Furthermore, the first radiation element 140 may also include a connection portion 148 disposed on the second surface E2 of the nonconductive support element 170, and the connection portion 148 may be further coupled to an auxiliary connection point CPA on the metal frame element 110. It should be noted that the term “adjacent” or “close” over the disclosure means that the distance (spacing) between two corresponding elements is smaller than a predetermined distance (e.g., 10 mm or the shorter), but often does not mean that the two corresponding elements directly touch each other (i.e., the aforementioned distance/spacing between them is reduced to 0). In some embodiments, the first radiation element 140 substantially has a bending L-shape, but it is not limited thereto.

The second radiation element 150 may extend from the second surface E2 onto the third surface E3 of the nonconductive support element 170. However, the disclosure is not limited thereto. In alternative embodiments, the second radiation element 150 is merely disposed on the second surface E2 of the nonconductive support element 170. Specifically, the second radiation element 150 has a first end 151 and a second end 152. The first end 151 of the second radiation element 150 is coupled to a second connection point CP2 on the metal frame element 110. The second end 152 of the second radiation element 150 is an open end. For example, the first connection point CP1, the second connection point CP2, and the auxiliary connection point CPA as mentioned above may be entirely different from each other. In some embodiments, the second radiation element 150 is adjacent to the feeding radiation element 130. Thus, a second coupling gap GC2 may be formed between the second end 152 of the second radiation element 150 and the first side 135 of the feeding radiation element 130. In some embodiments, the second radiation element 150 substantially has a variable-width straight-line shape, but it is not limited thereto.

The third radiation element 160 may extend from the first surface E1 onto the second surface E2 of the nonconductive support element 170. Specifically, the third radiation element 160 has a first end 161 and a second end 162. The first end 161 of the third radiation element 160 is coupled to the grounding point GP of the ground element 120. The second end 162 of the third radiation element 160 is an open end. In some embodiments, the third radiation element 160 further includes a parallelogram portion 165 positioned at the second end 162. In some embodiments, the third radiation element 160 is adjacent to the feeding radiation element 130. Thus, a third coupling gap GC3 may be formed between the parallelogram portion 165 of the third radiation element 160 and the second side 136 of the feeding radiation element 130.

In some embodiments, the antenna structure of the communication device 100 is formed by the metal frame element 110, the ground element 120, the feeding radiation element 130, the first radiation element 140, the second radiation element 150, and the third radiation element 160. For example, the signal source 190 may be an RF (Radio Frequency) module for exciting the antenna structure. It should be noted that since the antenna structure of the communication device 100 has a 3D (Three-Dimensional) shape, the aforementioned antenna structure can be well integrated with the metal frame element 110.

In some embodiments, the antenna structure of the communication device 100 can cover a first frequency band, a second frequency band, and a third frequency band. For example, the first frequency band may be from 1166 MHz to 1186 MHz, the second frequency band may be from 1710 MHz to 2690 MHz, and the third frequency band may be from 3300 MHz to 6000 MHz. Therefore, the antenna structure of the communication device 100 can support at least the wideband operations of GPS (Global Positioning System) and LTE (Long Term Evolution).

In some embodiments, the operational principles of the antenna structure of the communication device 100 will be described as follows. The first radiation element 140, the second radiation element 150, and the third radiation element 160 can be excited by the feeding radiation element 130 using respective coupling mechanisms. Specifically, the first radiation element 140 can be excited to generate the first frequency band, the second radiation element 150 can be excited to generate the second frequency band, and the third radiation element 160 can be excited to generate the third frequency band. According to practical measurements, after the metal frame element 110 is added and the first connection point CP1, the second connection point CP2 and the auxiliary connection point CPA are arranged, the ground element 120 and the first radiation element 140 can block the noise from the surrounding environment, and the effective resonant length of the second radiation element 150 can become longer. Furthermore, the first coupling gap GC1, the second coupling gap GC2, and the third coupling gap GC3 can be configured to fine-tune the impedance matching of the first frequency band, the second frequency band, and the third frequency band. It should be noted that since the metal frame element 110 is considered as an extension portion of the antenna structure of the communication device 100, its existence does not negatively affect the communication quality of the communication device 100.

In some embodiments, the element sizes of the communication device 100 will be described as follows. The length L1 of the first radiation element 140 may be substantially equal to 0.25 wavelength (λ/4) of the first frequency band of the antenna structure of the communication device 100. The length L2 of the second radiation element 150 may be substantially equal to 0.1667 wavelength (λ/6) of the second frequency band of the antenna structure of the communication device 100. The length L3 of the third radiation element 160 may be substantially equal to 0.25 wavelength (λ/4) of the third frequency band of the antenna structure of the communication device 100. Among the bifurcated portion 144 of the first radiation element 140, the length L4 of the long branch 145 may be at least twice the length L5 of the short branch 146, and the length L5 of the short branch 146 may be from 10 mm to 12 mm. The width of the first coupling gap GC1 may be from 1 mm to 2 mm. The width of the second coupling gap GC2 may be from 0.5 mm to 1.2 mm. The width of the third coupling gap GC3 may be from 0.2 mm to 0.6 mm. The above ranges of element sizes are calculated and obtained according to many experimental results, and they help to optimize the operational bandwidth and the impedance matching of the antenna structure of the communication device 100, and also to maximize the structural rigidity of the antenna structure of the communication device 100.

In some embodiments, the communication device 100 further includes a first conductive gasket 181, a second conductive gasket 182, and an additional conductive gasket 185. The shapes and the sizes of the first conductive gasket 181, the second conductive gasket 182, and the additional conductive gasket 185 are not limited in the disclosure. The ground element 120 may be further coupled through the first conductive gasket 181 to the first connection point CP1 on the metal frame element 110. The second radiation element 150 may be further coupled through the second conductive gasket 182 to the second connection point CP2 on the metal frame element 110, so as to increase the effective resonant length and decrease the resonant wavelength. The first radiation element 140 may be further coupled through the additional conductive gasket 185 to the auxiliary connection point CPA on the metal frame element 110, so as to reject the noise from the environment. It should be understood that the additional conductive gasket 185 is merely an optional component, which is omitted in other embodiments. In alternative embodiments, each of the first conductive gasket 181, the second conductive gasket 182, and the additional conductive gasket 185 is replaced with another conductive element, such as a pogo pin or a metal spring.

The disclosure proposes a novel communication device and a novel antenna structure therein. In comparison to the conventional design, the disclosure has at least the advantages of small size, wide bandwidth, high structural rigidity, low manufacturing cost, and being adaptive to different environments. Therefore, the disclosure is suitable for application in a variety of devices.

It should be noted that the above element sizes, element shapes, and frequency ranges are not limitations of the disclosure. An antenna designer can fine-tune these settings or values in order to meet specific requirements. It should be understood that the communication device of the disclosure is not limited to the configurations depicted in FIGS. 1-4. The disclosure may merely include any one or more features of any one or more embodiments of FIGS. 1-4. In other words, not all of the features displayed in the figures should be implemented in the communication device of the disclosure.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication device, comprising:
a metal frame element;
a ground element, coupled to a first connection point on the metal frame element;
a feeding radiation element, having a feeding point;
a first radiation element, coupled to the ground element, wherein the first radiation element is adjacent to the feeding radiation element;
a second radiation element, coupled to a second connection point on the metal frame element, wherein the second radiation element is adjacent to the feeding radiation element;
a third radiation element, coupled to the ground element, wherein the third radiation element is adjacent to the feeding radiation element; and
a nonconductive support element, disposed on the metal frame element, wherein the ground element, the feeding radiation element, the first radiation element, the second radiation element, and the third radiation element are distributed over the nonconductive support element;
wherein an antenna structure is formed by the metal frame element, the ground element, the feeding radiation element, the first radiation element, the second radiation element, and the third radiation element.

2. The communication device as claimed in claim 1, wherein the metal frame element is an internal component of the communication device.

3. The communication device as claimed in claim 1, wherein the nonconductive support element has a first surface, a second surface, a third surface, and a fourth surface, the second surface is positioned between the first surface and the third surface, and the fourth surface is attached to the metal frame element.

4. The communication device as claimed in claim 3, wherein the ground element is disposed on the first surface of the nonconductive support element.

5. The communication device as claimed in claim 3, wherein the feeding radiation element and the first radiation element extend from the first surface through the second surface onto the third surface of the nonconductive support element.

6. The communication device as claimed in claim 3, wherein the second radiation element extends from the second surface onto the third surface of the nonconductive support element.

7. The communication device as claimed in claim 3, wherein the third radiation element extends from the first surface onto the second surface of the nonconductive support element.

8. The communication device as claimed in claim 1, wherein the first radiation element comprises a bifurcated portion.

9. The communication device as claimed in claim 8, wherein a first coupling gap is formed between the feeding radiation element and the bifurcated portion of the first radiation element, and a width of the first coupling gap is from 1 mm to 2 mm.

10. The communication device as claimed in claim 1, wherein the feeding radiation element is disposed between the second radiation element and the third radiation element.

11. The communication device as claimed in claim 1, wherein a second coupling gap is formed between the second radiation element and the feeding radiation element, and a width of the second coupling gap is from 0.5 mm to 1.2 mm.

12. The communication device as claimed in claim 1, wherein a third coupling gap is formed between the third radiation element and the feeding radiation element, and a width of the third coupling gap is from 0.2 mm to 0.6 mm.

13. The communication device as claimed in claim 1, wherein the antenna structure covers a first frequency band, a second frequency band, and a third frequency band.

14. The communication device as claimed in claim 13, wherein the first frequency band is from 1166 MHz to 1186 MHz, the second frequency band is from 1710 MHz to 2690 MHz, and the third frequency band is from 3300 MHz to 6000 MHz.

15. The communication device as claimed in claim 13, wherein a length of the first radiation element is substantially equal to 0.25 wavelength of the first frequency band.

16. The communication device as claimed in claim 13, wherein a length of the second radiation element is substantially equal to 0.1667 wavelength of the second frequency band.

17. The communication device as claimed in claim 13, wherein a length of the third radiation element is substantially equal to 0.25 wavelength of the third frequency band.

18. The communication device as claimed in claim 1, further comprising:
a first conductive gasket, wherein the ground element is further coupled through the first conductive gasket to the first connection point on the metal frame element.

19. The communication device as claimed in claim 18, further comprising:
a second conductive gasket, wherein the second radiation element is further coupled through the second conductive gasket to the second connection point on the metal frame element.

20. The communication device as claimed in claim 1, further comprising:
an additional conductive gasket, wherein the first radiation element is further coupled through the additional conductive gasket to an auxiliary connection point on the metal frame element.
